(19) United States
(12) Patent Application Publication
(10) Pub. No.: US 2025/0337004 A1
(43) Pub. Date: Oct. 30, 2025

(54) COMPOSITE POLYMER CERAMIC ELECTROLYTE

(71) Applicant: Wildcat Discovery Technologies, Inc., San Diego, CA (US)

(72) Inventors: Sanpei Zhang, San Diego, CA (US); William Jesus Domingo, Fallbrook, CA (US); Bin Li, San Diego, CA (US); Gang Cheng, San Diego, CA (US); Deidre Strand, San Diego, CA (US)

(21) Appl. No.: 18/864,793

(22) PCT Filed: May 25, 2023
(86) PCT No.: PCT/US2023/023556

§ 371 Date: Nov. 11, 2024

Related U.S. Application Data
(60) Provisional application No. 63/346,498, filed on May 27, 2022.

(51) Int. Cl. H01M 10/056

(52) U.S. Cl. CPC H01M 10/056; H01M 2300/0091

(57) ABSTRACT

A composite useful for making a solid electrolyte is comprised of an electrolytic inorganic powder (EIP) embedded in matrix comprised of an unsaturated fluoropolymer, an electrolyte salt, and may include a reinforcing polymer. The composite may be formed by dissolving the unsaturated fluoropolymer, salt in a solvent with the EIP forming a slurry that may be dried and a reinforcing polymer added thereto (i.e., in the slurry or after the slurry is dried). The unsaturated fluoropolymer may be formed insitu in the slurry when making the composite.

### GOVERNMENT REFERENCE

This invention was made with government support under DE-EE0008853 awarded by the Department of Energy. The government has certain rights in the invention.

### TECHNICAL FIELD

This disclosure relates to solid state electrolytes for use in batteries. In particular, it relates to ceramic (inorganic solid particulate) polymer composite electrolytes.

### BACKGROUND

Rechargeable lithium metal batteries (LMBs), those having a lithium metal anode, could potentially double the cell-level energy of state-of-the-art lithium ion batteries (LIBSs) compared to those containing a carbon anode, due to the extremely low density, high theoretical capacity, and negative redox potential of Li metal. Unfortunately, the commercialization of LMBs is very challenging due to the high reactivity of Li metal anode, the growth of Li dendrites and the volume change during the battery operation. These consequences eventually lead to a low coulombic efficiency (CE), shortened battery life, sluggish electrode kinetics and safety issues.

Solid state electrolytes have been proposed to make batteries with lithium metal anodes. Used with advanced cathode technologies, this can contribute to a three-fold increase in the energy density of the battery. Current solid ion conductors either have good ionic conductivity (inorganics) or good processing/interfacial properties (polymers), but not both. Polymers incorporating inorganics have suffered from increased impedance across the inorganic and polymer interface as well as mechanical property deficiencies.

Accordingly, it would be desirable to provide a solid electrolyte that solves one or more problems of the prior art such as those described above. In particular, it would be desirable to provide a solid electrolyte that has improved ionic conductivity while having desirable mechanical characteristics to realize safe batteries with lithium metal anodes as well as easy processability for low cost manufacturing.

### SUMMARY

A first aspect of the invention is composite comprising, an electrolytic inorganic powder embedded in matrix comprised of an unsaturated fluoropolymer, an electrolyte salt, and a reinforcing polymer. The composite may have a high solid loading of the electrolytic inorganic powder with a high ionic conductivity and desirable mechanical characteristics when used as a solid state electrolyte in a battery. The ionic conductivity surprisingly may be higher than the ionic conductivity of the electrolytic inorganic powder.

A second aspect of the invention is a method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by:

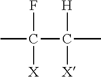

where X and X′ are each independently either hydrogen or an electron-withdrawing group, and
(ii) removing the solvent from the slurry to form the ceramic polymer composite, wherein the electrolytic inorganic powder is present in an amount of 45% to 99% by weight of the ceramic polymer composite.

A third aspect of the invention is a composite comprising, an electrolytic inorganic powder embedded in a matrix comprised of an unsaturated fluoropolymer, and an electrolyte salt, wherein the electrolyte salt and unsaturated fluoropolymer are each present in a salt ratio of electrolyte salt/unsaturated fluoropolymer of 0.5 to 10 by weight.

A fourth aspect of the invention is a method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by:

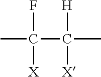

where X and X′ are each independently either hydrogen or an electron-withdrawing group.
(ii) removing the solvent from the slurry to form the ceramic polymer composite, wherein the electrolyte salt and unsaturated fluoropolymer are each present in a salt ratio of electrolyte salt/unsaturated fluoropolymer of 0.5 to 10 by weight.

### BRIEF DESCRIPTION OF THE DRAWINGS

FIG. 1 is a plot of the conductivity of a composite of this invention as function of salt concentration.

FIG. 2 is a scanning electron micrograph of the composite of this invention.

FIG. 3 is a plot of the conductivity of a composite of this invention as function of salt concentration.

### DETAILED DESCRIPTION

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

The composite is useful for making a solid state electrolyte. In one embodiment the composite is comprised of an electrolytic inorganic powder embedded in matrix comprised of an unsaturated fluoropolymer, an electrolyte salt, and a reinforcing polymer. In another embodiment the reinforcing polymer may be optional and the composite has an electrolyte salt/unsaturated fluoropolymer ratio of 0.5 to 10 by weight. Illustratively, the electrolytic inorganic powder may comprise from 5% or 10% to 95%, 75%, 50%, 25% or 20 by weight of the composite and may depending on the method to make the composite or desired application. For example, the composite when subject to pressing may desirably have a higher weight % such as greater than 40% or 50% to 95%, 85% or 75% by weight of the composite. The electrolyte salt may be any useful amount it is generally desirable to have an amount of electrolyte salt that has the ratio described herein. The amount of electrolyte salt, unsaturated fluoropolymer and other components (e.g., reinforcing polymer as described herein) make up the balance of the composite.

The unsaturated fluoropolymer may be any suitable such as those known in the art by dehydrofluorination of a fluoropolymer represented by:

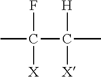

where X and X′ are each independently either hydrogen or an electron-withdrawing group. The hydrogen atom is sufficiently acidic to result in dehydrofluorination under sufficient basic conditions which may be mild (e.g., heating of DMF being sufficient as described by U.S. Pat. No. 3,507,844). Illustrative withdrawing groups include H, F, C₁₋₆ fluoroalkyls with perfluorinated groups being desirable (e.g., CF₃, C₂F₅, C₄F₉,) and lower fluoroakloxy groups (e.g., CF₂OR, or CF₄OR, where R is a C₁₋₆ alkyl or fluoroalkyl group with the fluoroalkyl group desirably being a perfluoro alkyl).

The unsaturated fluoropolymer can be any fluoropolymer comprising the above identified structural sequence. Such fluoropolymers are among the polymers, copolymers, terpolymers, and oligomers described in The Kirk-Othmer Encyclopedia of Chemical Technology, Volume 8, pages 990-1003 (4th ed. 1993). The fluoropolymer may be prepared from monomers comprising olefinic fluorinated monomers, including one or more of vinylidene fluoride (VDF), hexafluoropropylene (HPF), and tetrafluoroethylene (TFE), among others. Optionally, the fluoropolymer may be prepared from monomers further comprising other fluorinated olefinic monomers, or non-fluorinated olefinic monomers, including chlorotrifluoroethylene, trifluoroethylene, vinyl fluoride, a perfluoro (alkyvinyl ether), a perfluoro (alkoxyvinyl ether), ethylene, propylene, isobutylene, and the like.

The particular monomers used to produce the saturated fluoropolymer and the amounts of each, may be selected on the desired properties of the unsaturated polymer desired.

Exemplary unsaturated fluoropolymers may be formed from the polymerization of tetrafluoroethylene, hexafluoropropylene, vinylidene fluoride, and perfluoroalkyl vinyl ethers, such as perfluoromethylvinyl ether and perfluorobutylvinyl ether. The amounts may be any so long as the saturated fluoropolymer may be dehydrofluorinated to the desired degree to form the unsaturated fluoropolymer, with polyvinylidene fluoride (PVDF) being suitable. Useful PVDF's may include those commercially available such as those available from Solvay under the trade name PVDF5130 having a weight average molecular weight of 1300 kDa.

The dehydrofluorination may be carried out by any suitable process such as those known in the art, including for example, those described by U.S. Pat. Nos. 3,507,844; 4,742,126; 4,758,618 and 5,733,981, each incorporated herein by reference. In a particular method the unsaturated fluoropolymer may be formed in-situ during the method of forming the ceramic polymer composite as described herein.

The amount unsaturated fluoropolymer may be present in any useful amount in the composite. Illustratively, all of the saturated fluoropolymer that may be dehydrofluorinated (“dehydrofluoronatable fluoropolymer”) may be converted to the unsaturated fluoropolymer or only a portion of it may be converted (e.g., 10%, 20%, 30%, 40%, 50%, 60%, 70%, 80% 90% to 100% by mole or weight).

Electrolyte salts that are suitable for use in preparing the electrolyte compositions of the present disclosure include those salts that comprise at least one cation and at least one weakly coordinating anion (for example, a bis(perfluoroalkanesulfonyl)imide anion); that may be incorporated into the matrix of the composite and, in particular, the unsaturated fluoropolmer. The amount of electrolyte salt within the matrix may be any useful amount that realizes the desired conductivity without degrading the desired matrix mechanical characteristics. Typically, the amount of salt to the unsaturated fluoropolymer is present in weight ratio of salt/unsaturated fluoropolymer and saturated fluoropolymer that was not dehydrofluorinated of 10/1, 5/1, 4/1 or 3.5/1 to 1/10, 1/5, 1/2, 1, 1.2/1 or 1.5/1 by weight.

The salts may be stable over a range of operating voltages, are desirably non-corrosive, thermally and hydrolytically stable. Illustrative cations include alkali metal, alkaline earth metal, Group IIB metal, Group IIIB metal, transition metal, rare earth metal, and ammonium (for example, tetraalkylammonium or trialkylammonium) cations, as well as a proton. In some embodiments, cations for battery use include alkali metal and alkaline earth metal cations. Suitable anions include fluorine-containing inorganic anions such as (FSO2)2N—, BF4-, PF6-, AsF6-, and SbF6-; CIO4-; HSO4-; H2PO4-; organic anions such as alkane, aryl, and alkaryl sulfonates; fluorine-containing and nonfluorinated tetraarylborates; carboranes and halogen-, alkyl-, or haloalkylsubstituted carborane anions including metallocarborane anions; and fluorine-containing organic anions such as perfluoroalkanesulfonates, cyanoperfluoroalkanesulfonylamides, bis(cyano)perfluoroalkanesulfonylmethides, bis(perfluoroalkanesulfonyl)imides, bis(perfluoroalkanesulfonyl)methides, and tris(perfluoroalkanesulfonyl)methides; and the like.

Preferred anions for battery use include fluorine-containing inorganic anions (for example, (FSO2)2N—, BF4-, PF6-, and AsF6-) and fluorine-containing organic anions (for example, perfluoroalkanesulfonates, bis(perfluoroalkanesulfonyl)imides, and tris(perfluoroalkanesulfonyl)methides). The fluorine-containing organic anions can be either fully fluorinated, that is perfluorinated, or partially fluorinated (within the organic portion thereof). In some embodiments, the fluorine-containing organic anion is at least about 80 percent fluorinated (that is, at least about 80 percent of the carbon-bonded substituents of the anion are fluorine atoms). In some embodiments, the anion is perfluorinated (that is, fully fluorinated, where all of the carbon-bonded substituents are fluorine atoms). The anions, including the perfluorinated anions, can contain one or more catenary heteroatoms such as, for example, nitrogen, oxygen, or sulfur. In some embodiments, fluorine-containing organic anions include perfluoroalkanesulfonates, bis(perfluoroalkanesulfonyl)imides, and tris(perfluoroalkanesulfonyl)methides.

Exemplary salts include lithium hexafluorophosphate, lithium bis(trifluoromethanesulfonyl)imide, lithium bis(perfluoroethanesulfonyl)imide, lithium tetrafluoroborate, lithium perchlorate, lithium hexafluoroarsenate, lithium trifluoromethanesulfonate, lithium tris(trifluoromethanesulfonyl)methide, lithium bis(fluorosulfonyl)imide (LiFSI), and mixtures of two or more thereof.

The electrolytic inorganic powder (EIP) may be any useful inorganic powder that is a solid at the operating conditions of the battery and sufficiently ionically conductive such as a lithium metal oxide (LMO) that displays a sufficient ionic conductivity useful for making an electrolyte. Typically, the EIP has an ionic conductivity of at least about 1×10-6, 1×10-6 Siemen/cm (S/cm) or 1×10-4Siemen/cm (S/cm). The EIP, generally, may have any crystalline structure, but typically, when the EIP is an LMO, the structure is either cubic or a perovskite crystalline structure (e.g., cubic, or distorted structures thereof such as orthorhombic, tetragonal, or trigonal). Illustratively, the lithium metal oxide is a lithium metal zirconate having a cubic structure, which are often referred to a stabilized cubic zirconia. The metal of the lithium metal zirconate may be any useful to realize the stabilization of the cubic structure and desired ionic conductivity. Exemplary lithium metal zirconates are those wherein the metal is comprised of lanthanum and are commonly referred to as LLZO or LLMZO. Illustrative LLZO and LLMZOs include, for example, Li7La3Zr2012, Li6.75La3Zr1.75Ta0.25012, Li6.25La3Zr2A10.25012 or Li6.25Ga0.25La3Zr2012, Li5.5La3Nb1.75In0.25012. Examples of other metals that may be useful in the LLMZO structure include Mg, Ca, Y, Ce, and Hf.

The electrolytic LMO may be a lithium metal oxide having a perovskite crystalline such as lithium-lanthanum titanates (LLTO). Generally the LLTO may be represented by Li3xLa (2/3)-x M (1/3)-2xTiO3. The metal may be any useful for realizing the desired conductivity and stability of the LLTO. Examples of other metals include, for example, Al and Nb, Ta, Zr, Hf, Y or Zr.

With regard to any particular electrolytic lithium metal oxide powder or EIP, it is understood that the chemical formulas are an illustration and that the particular atomic stoichiometry may vary somewhat with each atomic amount independently varying from plus or minus 5%, 10% or 20% so long as charge neutrality is maintained for the EIP.

The LMO may be prepared by any suitable method such as those known in the art. For example, the LMO may be made by mixing the constituent oxides or hydroxides and heated to a temperature sufficient to form the desired LMO. Illustratively, a LLZO may be made from LiOH·H2O, ZrO2, La2O3 and MOx mixed together (e.g., ball milled or the like with media such as cubic stabilized zirconia milling media) with or without a liquid media such as a polar solvent such as an alcohol (e.g., isopropanol, ethanol, methanol or combination thereof). Commercially available LMO powders likewise may be used such as those available from Toshima, D50<1 micrometer, >99.9%, Japan.

EIPs other than LMOs may include those known in the art such as lithium halides, lithium hydrides, lithium nitrides, NASICONs, Argyrodite and LiSICON, such as described in Frontiers in Energy Research, June 2014, Vol. 2, Article 25.

The EIP is a powder that is embedded in a matrix comprised of the unsaturated fluoropolymer, electrolyte salt, and reinforcing polymer. The powder may be any practical for forming the composite that is useful to make a solid electrolyte therefrom. Generally, the EIP is of a size such that it is embedded within the matrix and fails to span the smallest dimension in an application (e.g., thickness of an electrode). It is also desirable the solids loading of the EIP is not so high that the EIP particles are not embedded within the matrix but are in particle-particle contact such that the mechanical properties are deleteriously impacted, which may cause reduction of ionic conductivity or failure in the application.

Surprisingly, electrolyte films of the composite at high volume loading of the EIP but not so high that the matrix of the composite is not substantially continuous and embeds essentially all of the EIP particles, may realize a higher ionic conductivity than the of the EIP powder itself. Generally, the conductivity is at least about 1×10-4 Siemen/cm (S/cm) or 1×10-5 (S/cm), which may be determined by any suitable method such as those known in the art. Measurement of ionic conductivity is performed using electrochemical impedance spectroscopy with the membrane embedded between two blocking electrodes (stainless steel spacers and indium electrodes). The spectra were collected in the frequency range between 100 mHz and 7 MHz applying an AC voltage of 7 mV. Experimental data were fitted using a (R1/Q1)-(R2/Q2)-Q3 equivalent circuit, corresponding to RSE bulk, RSE interface and Warburg impedance, respectively. The conductivity was calculated by the equation:

$$σ = l / ( Rb \cdot A )$$

where σ was the ionic conductivity, l was the thickness, R_{b} was the bulk resistance, and A was the area of the electrolyte film.

Generally, the EIP has a particle size that is useful for making the composite, and typically has a median particle size (D₅₀), by volume, from about 0.1 micrometer (μm), 0.5 (μm), 1 (μm), 2 μm, 5 μm or 10 μm to 20 μm, 30 μm, 50 μm or 75 μm. The particles may have any suitable particle size distribution (PSD) with a distribution that is able to pack to high density allow, for example, particles to pack within interstitial voids between particles to realize a more uniform distance between particles spanned by the matrix of the composite. Desirably, the D₉₀ is at most 150 μm, 100 μm or 50 μm and a D₁₀ of at least 0.1 μm, 0.5 μm or 1 μm by volume. D₉₀ means the particle size (equivalent spherical diameter) in the particle size distribution, where 90% by volume of the particles are less than or equal to that size; similarly, D₅₀ means the particle size (equivalent spherical diameter) in the particle size distribution, where at least 50% by volume of the particles are less than that size, and D₁₀ means the particle size (equivalent spherical diameter) in the particle size distribution, where at least 10% by volume of the particles are less than that size. The particle size may be determined by any suitable method such as those known in the art including, for example, laser diffraction or image analysis of micrographs of a sufficient number of particles (˜100 to ˜200 particles). A representative laser diffractometer is one produced by Microtrac such as the Microtrac S3500.

The EIP has any useful specific surface area, but desirably has a sufficient surface area realize sufficient interface and connection with the matrix previously described. It is not understood and in no way limiting that the ionic conductivity greater than the EIP may be related to interface interaction of the matrix and EIP powder over certain particle separation distances. The surface area of the EIP powder may desirably be 0.05, 0.1 m²/g to 30 or 20 m2/g as determined by nitrogen adsorption by ISO 9277:2010.

The composite may have any useful solids loading of the EIP that is useful to make, for example, an electrolyte for use in an electrical device. The amount of EIP within the composite may be from 10% to 95% by volume of the composite. But to realize higher desired conductivity, it has been surprisingly discovered the composite by combining a further reinforcing polymer as described herein allows for an electrode having improved ionic conductivity while having sufficient mechanical integrity to withstand the processing of an electrode to make a battery and under operating conditions experienced in the battery. For example, the amount of the EIP may be above 45%, 50% or 60% to 90%, 85% or 80% by volume. It has been discovered that the highly filled composite is particularly useful for mitigating undesired growth from electrodes such as dendrites from lithium metal electrodes. Without being limiting, this may be due to the mechanical integrity of the composite and hardness of the inorganic particles therein acting as a barrier to the dendrites.

The reinforcing polymer may be any suitable that adds a sufficient amount of rigidity and strength while still realizing the desired ionic conductivity of the composite. Illustratively, the reinforcing polymer may be any that undergoes fibrillation. Examples of such fibrillating polymers include a polyolefin (e.g., isotactic polypropylene or copolymer thereof), polytetrafluorethylene (PTFE), or perfluoroalkyoxy alkane. Illustrative, the reinforcing polymer is a PTFE powder that may be paste extruded at room temperature (i.e., 20 to 30° C.). Known PTFE powders and dispersions may be used such as those known under TEFLON tradename from Chemours and PTFE powder and dispersions available from Daikin America, Inc. Typically, the reinforcing polymer is in the form of a powder or dispersion where the particle size may be any useful to form the composite. Typically, the powder or particle size within a dispersion is less than 1000, 500, 250 or 100 micrometers to about 0.5 1, 2, or 5 micrometers.

The amount of the reinforcing polymer in the composite may be any that is useful. It is desirably present in the composite in low concentrations to minimize any disturbance of the matrix ionic conductivity. Typically, the amount of reinforcing polymer is from 0.1%, 0.2%, 0.3% to 1%, 2% or 3%. Typically, at least a portion of the reinforcing polymer is present in form of fibrils. Generally, the amount of the reinforcing polymer that is present as fibrils is at least about 50%, 75%, 90% or all of the reinforcing polymer is present as fibrils by volume. The amount of the reinforcing polymer that is present as fibrils may be determined microscopically by known methods including the use of commercially digital vision software.

The composite may be comprised of a further additive such as those that may be useful in a battery and may include additives useful to form a shaped article from the composite such as a lubricant and surfactant. The additive may include inert fillers and other useful components such as flame retardants.

The composite may be made by any suitable method. Illustratively, the composite may be made by dissolving the unsaturated fluoropolymer, electrolyte salt and dispersing the EIP in a solvent that dissolves the unsaturated fluoropolymer and electrolyte salt such as a polar aprotic solvent such as those known in the art. Examples, of polar aprotic solvents that may be useful include, ketone (e.g., acetone, di-isopropyl ketone and methyl butyl ketone), aliphatic or aromatic halogenated hydrocarbon solvent (e.g., chloromethane, dichloromethane, trichloromethane, 1,2-dichloroethane, or 1,1,1-trichloroethane, chlorobenzene, 1,2-dichlorobenzene, 1,3-dichlorobenzene, and 1,2,3-trichlorobenzene), carbonate (e.g., propylene carbonate (PC), ethylene carbonate (EC), butylene carbonate (BC), chloroethylene carbonate, fluorocarbonate solvents (e.g., fluoroethylene carbonate and trifluoromethyl propylene carbonate), as well as the dialkylcarbonate solvents, such as dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

Some examples of sulfone solvents include methyl sulfone, ethyl methyl sulfone, methyl phenyl sulfone, methyl isopropyl sulfone (MIPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl)toluene, 2-(methylsulfonyl)ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl)sulfone and 2-methoxyethoxyethyl(ethyl)sulfone).

The polar aprotic solvent may also be silicon-containing, e.g., a siloxane or silane. Some examples of siloxane solvents include hexamethyldisiloxane (HMDS), 1,3-divinyltetramethyldisiloxane, the polysiloxanes, and polysiloxane-polyoxyalkylene derivatives. Some examples of silane solvents include methoxytrimethylsilane, ethoxytrimethylsilane, dimethoxydimethylsilane, methyltrimethoxysilane, and 2-(ethoxy)ethoxytrimethylsilane.

Other examples of polar aprotic solvents include diethyl ether, 1,2-dimethoxyethane, 1,2-diethoxyethane, 1,3-dioxolane, tetrahydrofuran, 2-methyltetrahydrofuran, tetrahydropyran, diglyme, triglyme, 1,3-dioxolane, and the fluorinated ethers (e.g., mono-, di-, tri-, tetra-, penta-, hexa- and per-fluoro derivatives of any of the foregoing ethers and 1,4-butyrolactone, ethylacetate, methylpropionate, ethylpropionate, propylpropionate, methylbutyrate, ethylbutyrate, the formates (e.g., methyl formate, ethyl formate, or propyl formate), and the fluorinated esters (e.g., mono-, di-, tri-, tetra-, penta-, hexa- and per-fluoro derivatives of any of the foregoing esters). Some examples of nitrile solvents include acetonitrile, benzonitrile, propionitrile, and butyronitrile. Some examples of sulfoxide solvents include dimethyl sulfoxide, ethyl methyl sulfoxide, diethyl sulfoxide, methyl propyl sulfoxide, and ethyl propyl sulfoxide. Some examples of amide solvents include formamide, N,N-dimethylformamide, N,N-diethylformamide, acetamide, dimethylacetamide, diethylacetamide, gamma-butyrolactam, and N-methylpyrrolidone.

The polar aprotic solvent may also be diethyl ether, tetrahydrofuran, and dioxane, hexamethylphosphoramide (HMPA), N-methylpyrrolidinone (NMP), 1,3-dimethyl-3,4,5,6-tetrahydro-2 (1H)-pyrimidinone (DMPU), and propylene glycol monomethyl ether acetate (PGMEA).

The unsaturated fluoropolymer may be formed prior to and then dissolved with the salt and dispersed with the EIP to form a slurry. The unsaturated fluoropolymer may be made as previously described. The unsaturated fluoropolymer may be made in situ when forming the slurry. When doing so, the slurry should have sufficient basicity to cause the dehydrofluorination of the saturated fluoropolymer dissolved in the solvent. The basicity may arise from the EIP having sufficient basic groups to cause the dehydrofluorination and form the unsaturated fluoropolymer. If desired, if the EIP is lacking a sufficient amount of basic groups it may be treated with a base, for example, LiOH—H2O in a solvent (including water) that is removed prior to forming the slurry having the dissolved salt and unsaturated fluorpolymer. Generally, the EIP has sufficient basicity when a 10% by weight aqueous slurry of the EIP has a pH of at least about 10.5. A separate base may be added to the solution or heating of a solvent such as DMF as described in the previously referenced U.S. Pat. Nos. 3,507,844; 4,742,126; 4,758,618 and 5,733,981 to form the unsaturated fluoropolymer. Any residual HF that may be produced by unsaturating the saturated fluoropolymer may be neutralized by any suitable method such as those known in the art including, for example, those common in the formation of cross-linked elastomeric fluoropolymers such as those known in the art under the VITON tradename from Chemours. If desired, the unsaturated polymer may be partially cross-linked, by known methods such as described in WO 2016/100421.

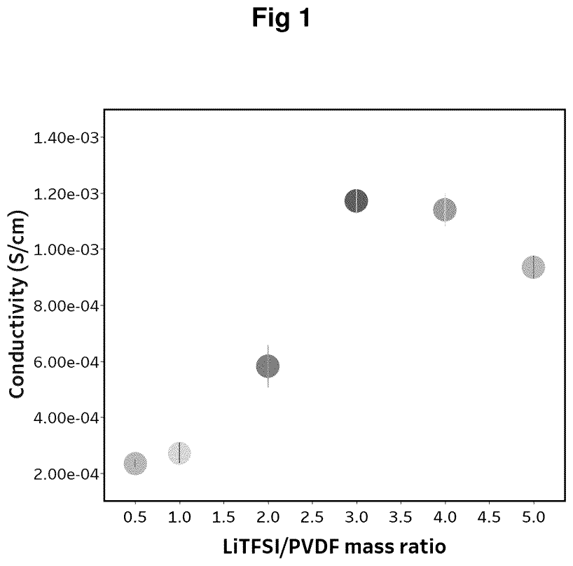

After the slurry is formed, the solvent may be removed by a suitable method such as those known in the art. Examples, include any method that uses evaporation, sublimation, critical fluid drying or the like to remove the solvent. Examples, include but are not limited to spray drying, casting into a film and evaporating the solvent, vacuum drying and the like. When casting to form the composite, the slurry may be cast directly on substrate such as a metal (e.g., aluminum or copper). These compositions may desirably have an EIP content of 10% to 20% by weight and the balance being the unsaturated fluoropolymer and a lithium salt with the lithium salt/unsaturated fluoropolymer being at least 0.5, 1 or 1.2 to at most 2 or 3. Salt ratios in these illustrations may be limited by the mechanical properties of the films formed when the salt ratio is above about 2 even though the conductivity is still increasing in a similar fashion as in FIG. 1. The unsaturated fluoropolymer may be formed prior to making the slurry or insitu as described herein. The film may be any useful thickness useful to make the composite for use in a battery (e.g., 10 or 20 micrometers to 250 or 500 micrometers).

Once, the solvent has been removed the resultant dried slurry may be granulated and compounded with the reinforcing polymer. The compounding may be performed in any suitable mixer or compound extruder, which may be heated to below the melt temperature of the unsaturated fluoropolymer and reinforcing polymer and shearing to form the composite, with at least a portion of the reinforcing polymer to desirably becoming fibrillated. Illustratively, a twin-screw extruder may be used to compound the dried slurry and the reinforcing polymer to realize the composite while also forming sheets that are useful for making electrodes. A twin screw extruder may also be used to dry the slurry via vents along its length and then extrude sheets from the in-situ extruder dried slurry. In another illustration, the dried slurry may be granulated and mixed with the reinforcing polymer to form a paste that may then be pressed to form sheets (e.g., roll or die pressed).

The reinforcing polymer may be added to the slurry of EIP and dissolved salt and unsaturated fluoropolymer. When added to the slurry, the reinforcing polymer may be dissolved or may be added as a powder that does not dissolve in the solvent (e.g., PTFE). After removal of the solvent, the composite may be further granulated, shaped and compounded as described above.

### Illustrations

Illustration 1: A composite comprising, an electrolytic inorganic powder embedded in a matrix comprised of an unsaturated fluoropolymer, an electrolyte salt, and a reinforcing polymer.

Illustration 2: The composite of claim 1, wherein the electrolytic inorganic powder has an ionic conductivity of at least 1×10-6 Siemen/cm (S/cm).

Illustration 3: The composite of claim 2, wherein the electrolytic inorganic powder is a lithium metal oxide powder having a cubic or perovskite crystalline structure.

Illustration 4: The composite of claim 3, wherein the lithium metal oxide powder has the cubic structure.

Illustration 5: The composite of claim 4, wherein the electrolytic lithium metal oxide powder is a lithium metal zirconate powder.

Illustration 6: The composite of any one of the preceding claims wherein the electrolytic inorganic powder has a specific surface area of 0.05 m2/g to 30 m2/g.

Illustration 7: The composite of any one of the preceding claims wherein the electrolytic inorganic powder comprises greater than 40% to 95% by weight of the composite.

Illustration 8: The composite of claim 7, wherein the electrolytic inorganic powder comprises 50% to 90% by weight of the composite.

Illustration 9: The composite of any one of the preceding claims wherein the reinforcing polymer is a polyolefin, a polytetrafluoroethylene, or a perfluoroalkoxy alkane.

Illustration 10: The composite of any one of the preceding claims wherein at least a portion of the reinforcing polymer is present as acicular grains.

Illustration 11: The composite of claim 10, wherein essentially all of the reinforcing polymer are acicular grains.

Illustration 12: The composite of any one of the preceding claims, wherein the reinforcing polymer acicular grains have an aspect ratio of at least about 10 to 1000.

Illustration 13: The composite of claim 1, wherein the unsaturated fluoropolymer is a fluoropolymer that has been dehydrofluorinated and is represented by:

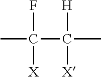

where X and X′ are each independently either hydrogen or an electron-withdrawing group.

Illustration 14: The composite of claim 12, wherein the electron-withdrawing group is F, CF3, C2F5, C4F9, CF2OR, or CF4OR, where R is a C1-6 alkyl or fluoroalkyl group.

Illustration 15: The composite of any one of the preceding claims wherein the reinforcing polymer is present in an amount of 0.1% to 5% by weight of the composite.

Illustration 16: The composite of claim 15, wherein the reinforcing polymer is present in an amount of at most about 2% by weight of the composite.

Illustration 17: The composite of any one of the preceding claims, wherein the electrolyte salt and unsaturated fluoropolymer are each present in an amount by weight, wherein the amount of electrolyte salt/unsaturated fluoropolymer is a salt ratio of 0.5 to 5.

Illustration 18: The composite of claim 17, wherein the salt ratio is from 2 to 3.5.

Illustration 19: The composite of any one of the preceding claims, wherein the electrolyte salt is comprised of one or more of: lithium hexafluorophosphate, lithium bis(trifluoromethanesulfonyl)imide, lithium bis(perfluoroethanesulfonyl)imide, lithium tetrafluoroborate, lithium perchlorate, lithium hexafluoroarsenate, lithium trifluoromethanesulfonate, lithium tris(trifluoromethanesulfonyl)methide, and lithium bis(fluorosulfonyl)imide (Li—FSI).

Illustration 20: The composite of any one of the preceding claims, wherein the ionic conductivity is greater than the ion conductivity of either the unsaturated fluoropolymer or electrolytic lithium metal oxide.

Illustration 21: A method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by:

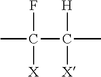

where X and X′ are each independently either hydrogen or an electron-withdrawing group, and
(ii) removing the solvent from the slurry to form the ceramic polymer composite, wherein the electrolytic lithium metal oxide is present in an amount of 45% to 99% by weight of the ceramic polymer composite.

Illustration 22: The method of claim 21, wherein the unsaturated fluoropolymer is formed during the mixing.

Illustration 23: The method of either claim 21 or 22, wherein the method further comprises incorporating of a reinforcing polymer into the ceramic polymer composite.

Illustration 24: The method of claim 23, wherein the incorporating of the reinforcing polymer is performed after removing of the solvent.

Illustration 25: The method of any one of claims 21 to 24, wherein the amount of electrolytic inorganic powder is at least 70% by weight the ceramic polymer composite.

Illustration 26: The method of claim 25 wherein the electrolytic inorganic powder is a cubic lithium zirconate powder comprised of a stabilizing metal atom.

Illustration 27: The method of claim 26, wherein the stabilizing metal atom is comprised of one or more of Mg, Ca, Y, Ce, Al, Nb and Hf.

Illustration 28: The method of claim 27, wherein the stabilizing atom is comprised of at least one of La, Ta and Al.

Illustration 29: The method of any one of claims 21 to 28, wherein at least 10% of the dehydrofluorinatable groups of the unsaturated fluoropolymer:

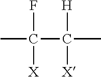

where X and X′ are each independently either hydrogen or an electron-withdrawing group have been dehydrofluorinated to C═C bonds.

Illustration 30: The method of claim 29, wherein essentially all of the dehydrofluorinatable groups have been converted to C═C.

Illustration 31: The method of any one of claims 21 to 30, wherein the solvent is an aprotic polar solvent.

Illustration 32: The method of claim 31, wherein the solvent is a cyclic solvent.

Illustration 33: The method of any of claims 23 to 32, further comprising shearing of the ceramic polymer composite to form a shaped article, wherein the shearing causes at least a portion of the reinforcing polymer to fibrillate.

Illustration 34: The method of claim 33, wherein shearing is by extruding or pressing.

Illustration 35: The method of any one of claims 23 to 34, wherein the reinforcing polymer is polytetrafluoroethylene.

Illustration 36: The method of any one of claims 21 to 35, wherein the unsaturated fluoropolymer is polyvinylidene fluoride.

Illustration 37: The method of any one of claims 21 to 36, wherein the ceramic polymer composite is comprised of a further additive.

Illustration 38: The method of claim 37, wherein the further additive is comprised of at least one of a surfactant and lubricant.

Illustration 39: The method of any one of claims 22 to 37, wherein the reinforcing polymer is a dispersion of particles in a liquid.

Illustration 40: A composite comprising, an electrolytic inorganic powder embedded in a matrix comprised of an unsaturated fluoropolymer, and an electrolyte salt, wherein the electrolyte salt and unsaturated fluoropolymer are each present in a salt ratio of electrolyte salt/unsaturated fluoropolymer of 0.5 to 10 by weight.

Illustration 41: The composite of claim 40, wherein the salt ratio is 1 to 5.

Illustration 42: The composite of claim 41, wherein the weight ratio is 1.2 to 5.

Illustration 43: The composite of any one of claims 40 to 42, wherein the electrolytic inorganic powder is present in an amount of at least 5% to 99% by weight of the composition.

Illustration 44: The composite of claim 43, wherein the amount of inorganic powder is at least 10% to 70% by weight of the composite.

Illustration 45: The composite of claim 44, wherein the amount of inorganic powder is at most 20% by weight of the composite.

Illustration 46: The composite of any one of claims 40 to 45, wherein the electrolyte salt is comprised of a salt having cation comprised of an alkali metal and an anion comprised of fluorine.

Illustration 47: The composite of claim 46, wherein the salt is comprised of one or more of lithium hexafluorophosphate, lithium bis(trifluoromethanesulfonyl)imide, lithium bis(perfluoroethanesulfonyl)imide, lithium tetrafluoroborate, lithium hexafluoroarsenate, lithium trifluoromethanesulfonate, lithium tris(trifluoromethanesulfonyl)methide, lithium bis(fluorosulfonyl)imide (Li—FSI).

Illustration 48: A method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by:

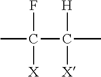

where X and X′ are each independently either hydrogen or an electron-withdrawing group.
(ii) removing the solvent from the slurry to form the ceramic polymer composite, wherein the electrolyte salt and unsaturated fluoropolymer are each present in a salt ratio of electrolyte salt/unsaturated fluoropolymer of 0.5 to 10 by weight.

Illustration 49: The method of claim 48, wherein the unsaturated fluoropolymer is formed during the mixing.

Illustration 50: The method of either claim 48 or 49, wherein the method further comprises incorporating of a reinforcing polymer into the ceramic polymer composite.

Illustration 51: The method of claim 50, wherein the incorporating of the reinforcing polymer is performed after removing of the solvent.

Illustration 52: The method of any one of claims 48 to 51, wherein the amount of electrolytic inorganic powder is at least 70% by weight the ceramic polymer composite.

Illustration 53: The method of claim 52 wherein the electrolytic inorganic powder is a cubic lithium zirconate powder comprised of a stabilizing metal atom.

Illustration 54: The method of claim 53, wherein the stabilizing metal atom is comprised of one or more of Mg, Ca, Y, Ce, Al, Nb and Hf.

Illustration 55: The method of claim 54, wherein the stabilizing atom is comprised of at least one of La, Ta and Al.

Illustration 56: The method of any one of claims 48 to 55, wherein at least 10% of the dehydrofluorinatable groups of the unsaturated fluoropolymer:

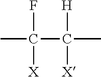

where X and X′ are each independently either hydrogen or an electron-withdrawing group have been dehydrofluorinated to C═C bonds.

Illustration 57: The method of claim 56, wherein essentially all of the dehydrofluorinatable groups have been converted to C═C.

### EXAMPLES

The following examples are provided to illustrate the invention, but are not intended to limit the scope. All parts and percentages are by weight unless otherwise indicated.

### Lithium Metal Oxide (LMO) Preparation:

Precursor powders [Li6.4La3Zr1.4Ta0.6012 (LLZTO), Li6.25La3Zr2A10.25012 (LLZAO) or Li6.25Ga0.25La3Zr2012 (LLZGO) are prepared from their corresponding individual precursor oxides and hydroxides: LiOH·H2O, La2O3, ZrO2 and MOx in the desired stoichiometric ratio. The precursors are planetary ball milled (Retsch) at 4G force for 12 h in isopropanol (IPA) using yttrium stabilized zirconium oxide beads (5 mm, MSE Supplies LLC). The IPA is removed and the dried mixture is calcinated at 950° C. for 6 h in an alumina crucible under air. The formed LMO is further ball milled to a size of about 0.1 m²/g.

### Examples 1-6

0.75 g of PVDF (5130, Solvay), 3 g of LiTFSI (Lithium bis(trifluoromethanesulfonyl)imide, Sigma, anhydrous, >99.99%) and 11.25 g of LLZTO were mixed with 30 g of NMP (1-Methyl-2-pyrrolidone, Sigma, anhydrous, 99.5%), followed with sonication under 20° C. for 30 mins. The mixture displays a color change from clear to a dark brown indicative of the PVDF dehydrofluorinating. After mixing, the slurry is put into a 250 ml glass jar and dried in oven at 80° C. under vacuum for 72 hours.

9.95 g of the dried slurry powder is mixed with 0.05 g PTFE dispersion powder (Sigma) by using a spatula on a hot surface (130° C.) for 5 minutes to form the composite. The composite is roll pressed to form a sheet of that is about 100 μm thick.

The composite ionic conductivity is determined as described herein.

The battery performance of the composite as a solid electrolyte is tested using cells made as follows. Cathodes are made using: Active material (90 wt %), conductive carbon black (5 wt %), and poly(vinylidene fluoride) binder (5 wt %, Aldrich) in N-methyl pyrrolidone were mixed into a homogeneous slurry. The active material is LiFePO4 or LiNi0.6Mn0.2Co0.2O2. The slurry is cast on an Al foil by an automatic film applicator, followed by drying in a vacuum oven for 12 h at 80° C. After the electrode disks were cut to 1.4 cm diameter, the disk was used as the cathode of the cell.

All solid-state batteries employing Gelon Li chips (15.6 mm, 250 μm), composite solid electrolyte film (50 μm) and LFP/NMC cathode (described above) were assembled in an argon-filled glovebox and tested without any treatment.

The compositions of the Composites of Examples 1-6 are shown in Table 1. The amount of reinforcing polymer PTFE is held constant at 0.5% by weight of the dried slurry of the PVDF, salt and LLZTO.

TABLE 1

| | weight % | weight % | weight % |
|---|---|---|---|
| Example | LLZTO | LiTFSI | PVDF |
| 1 | 75 | 8.33 | 16.67 |
| 2 | 75 | 12.25 | 12.25 |
| 3 | 75 | 16.67 | 8.33 |
| 4 | 75 | 18.75 | 6.25 |
| 5 | 75 | 20 | 5 |
| 6 | 75 | 20.83 | 4.17 |

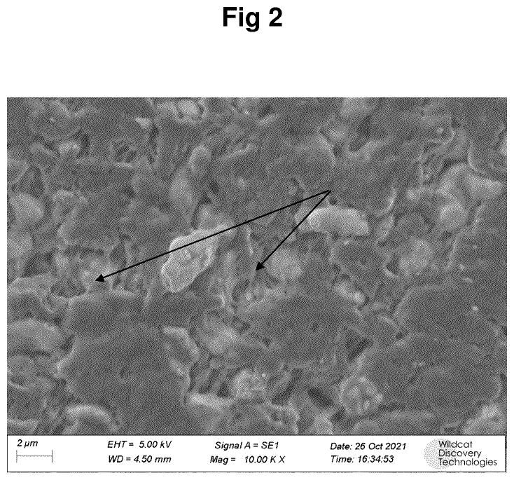

The composites of Examples 1-6 are shown in FIG. 1, in which the effect of salt/PVDF mass ratio is shown. From FIG. 1, it is apparent that the method may realize ionic conductivity greater than the ionic conductivity of the LLZTO (1 mS/cm, 25° C.). FIG. 2 is a scanning electron micrograph showing fibrils of the PTFE reinforcing polymer.

### Examples 7 and 8

Examples 7 and 8 are made the same way as Example 4 except that LLZGO and LLZAO are used in place of LLZTO respectively. The Example 7 composite (LLZGO) had a conductivity of 1.8 mS/cm. The Example 8 composite (LLZAO) had a conductivity of 0.6 mS/cm. In all cases, the conductivity is greater than the bulk ionic conductivity of the LMO powder.

The activation energy is determined from the conductivity as a function of temperature using:

$${σ}_{T} = {σ}_{0} exp ( - \frac{{E}_{a}}{{k}_{β} T} )$$

where σ_{T} is the total conductivity, σ₀ is the pre-exponential parameter, T is absolute temperature, Eₐ is the activation energy and k_{β} is the Boltzmann constant. The Eₐ for conduction, calculated from the slope of an Arrhenius plot, was 0.11 eV, which is lower than the range of 0.2-0.3 eV of most solid-state electrolytes, including the bulk LLZTO.

Each of the Examples 4, 7 and 8 composite is made into a coin cell with a lithium metal anode, and various cathode materials (e.g., (Li(Ni0.6Mn0.2Co0.2) 02 and lithium iron phosphate) sandwiching the composite. The cell was then charged/discharged galvanostatically at a C/10 rate in the voltage range between 3 and 4.25 V versus Li+/Li under 30° C. Each of the cells displays stable cycling. Regardless of the cathode, each cell demonstrated a high capacity close to its theoretical value.

### Examples 9-13

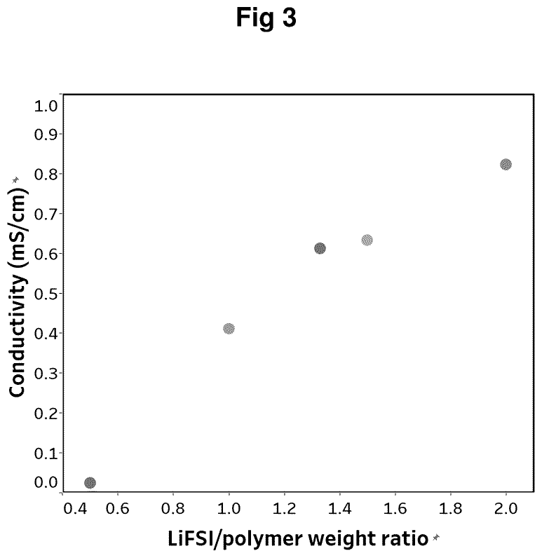

Examples 8-12 are made in the same way except the salt ratio is varied as shown in FIG. 3. An illustration of these examples (˜1.2 salt ratio) is as follows, 36.6 wt. % of PVDF (5130, Solvay), 48.8 wt. % of LiFSI (lithium bis(fluorosulfonyl)imide (LiFSI), Sigma, anhydrous, >99.9%) and 14.6 wt. % of LLZTO were mixed with DMF (1-Methyl-2-pyrrolidone, Sigma, anhydrous, 99.5%), followed with sonication under 20° C. for 30 mins. The slurry mixture displays a color change from clear to a dark brown indicative of the PVDF dehydrofluorinating. After mixing for about 12 hours, the slurry is cast onto a copper foil and dried for about 12 hours at 60° C. under vacuum. The composite has an ionic conductivity of about 0.61 mS/cm at room temperature. Examples 10-12 are made in the same way except the salt ratio is varied as shown in FIG. 3. The Example having a salt ratio about 2 is not able to be formed into a free-standing film.

### Comparative Example 1

Example 1 is repeated except that commercial LLZTO powder available from Toshima. No dehydrofluorination is observed as indicated by no color change. The composite displayed significantly lower ionic conductivity.

What is claimed is:

1. A composite comprising, an electrolytic inorganic powder embedded in a matrix comprised of an unsaturated fluoropolymer, an electrolyte salt, and a reinforcing polymer.

2. The composite of claim 1 wherein the electrolytic inorganic powder comprises greater than 40% to 95% by weight of the composite.

3. The composite of claim 1 reinforcing polymer is a polyolefin, a polytetrafluoroethylene, or a perfluoroalkoxy alkane.

4. The composite of claim 1 wherein at least a portion of the reinforcing polymer is present as acicular grains.

5. The composite of claim 4, wherein essentially all of the reinforcing polymer are acicular grains.

6. The composite of claim 1, wherein the unsaturated fluoropolymer is a fluoropolymer that has been dehydrofluorinated and is represented by: 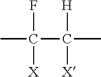
where X and X′ are each independently either hydrogen or an electron-withdrawing group.

7. The composite of claim 1, wherein the reinforcing polymer is present in an amount of 0.1% to 5% by weight of the composite.

8. The composite of claim 1, wherein the electrolyte salt and unsaturated fluoropolymer are each present in an amount by weight, wherein the amount of electrolyte salt/unsaturated fluoropolymer is a salt ratio of 0.5 to 5.

9. The composite of claim 1, wherein the composite's ionic conductivity is greater than the unsaturated fluoropolymer's or electrolytic lithium metal oxide's ionic conductivity.

10. A method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by: 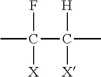
where X and X′ are each independently either hydrogen or an electron-withdrawing group, and
(ii) removing the solvent from the slurry to form the ceramic polymer composite, wherein the electrolytic inorganic powder is present in an amount of 45% to 99% by weight of the ceramic polymer composite.

11. The method of claim 10, wherein the unsaturated fluoropolymer is formed during the mixing.

12. The method of claim 10, wherein the method further comprises incorporating of a reinforcing polymer into the ceramic polymer composite.

13. The method of claim 12, further comprising shearing of the ceramic polymer composite to form a shaped article, wherein the shearing causes at least a portion of the reinforcing polymer to fibrillate.

14. A composite comprising, an electrolytic inorganic powder embedded in a matrix comprised of an unsaturated fluoropolymer, and an electrolyte salt, wherein the electrolyte salt and unsaturated fluoropolymer are each present in a salt ratio of electrolyte salt/unsaturated fluoropolymer of 0.5 to 10 by weight.

15. The composite of claim 14, wherein the salt ratio is 1 to 5.

16. The composite of claim 14, wherein the amount or electrolytic inorganic powder is 10% to 20% by weight of the composite.

17. The composite of claim 14, wherein the electrolyte salt is comprised of a salt having cation comprised of an alkali metal and an anion comprised of fluorine.

18. A method to form a ceramic polymer composite, comprising:
(i) mixing an electrolytic inorganic powder, an unsaturated fluoropolymer of a saturated fluoropolymer that has undergone dehydrofluorination, an electrolyte salt and a solvent that dissolves the unsaturated fluoropolymer and electrolyte salt to form a slurry, the saturated fluoropolymer being represented by: 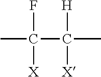
where X and X′ are each independently either hydrogen or an electron-withdrawing group.
(ii) removing the solvent from the slurry to form the ceramic polymer composite, wherein the electrolyte salt and unsaturated fluoropolymer are each present in a salt ratio of electrolyte salt/unsaturated fluoropolymer of 0.5 to 10 by weight.

19. The method of claim 18, wherein the unsaturated fluoropolymer is formed during the mixing.

20. The method of claim 19 further comprising casting the slurry on a metal foil and removing the solvent by heating under a vacuum.
